(19) United States
(12) Patent Application Publication
(10) Pub. No.: US 2024/0232191 A9
(43) Pub. Date: Jul. 11, 2024

(54) PERMISSION-BASED INDEX FOR QUERY PROCESSING

(71) Applicant: International Business Machines Corporation, Armonk, NY (US)

(72) Inventors: Jia Tian Zhong, BEIJING (CN); Peng Hui Jiang, BEIJING (CN); Ming Lei Zhang, BEIJING (CN); Ting Ting Zhan, BEIJING (CN); Le Chang, BEIJING (CN); Zhen Liu, BEIJING (CN); Xiao Yan Tian, BEIJING (CN)

(21) Appl. No.: 17/970,626

(22) Filed: Oct. 21, 2022

(51) Int. Cl. G06F 16/2453; G06F 11/34; G06F 21/62

(52) U.S. Cl. CPC G06F 16/24542; G06F 11/3409; G06F 21/6218; G06F 2221/2141

(57) ABSTRACT

An example operation may include one or more of storing an index that comprises identifiers of role-based access privileges for a plurality of users with respect to a database, receiving a database query associated with a user from a software program, identifying data records within the database that the user has permission to access based on database accessibility rights of the user stored within the index, prior to execution of the database query, loading the identified data records into the memory and filtering out other data records from the database which the user does not have permission to access, and executing the database query on the identified data records loaded from the database and returning query results from the execution to the software program.

### BACKGROUND

A query optimizer is common in relational database systems. The role of the query optimizer is to determine the most efficient way to execute a given database query. To do this, the query optimizer typically generates many different options (possible query plans) and determines the “cost” associated with each query. The different possible query plans can be generated by changing the order of instructions (e.g., join operations, etc.) within the query. Based on these costs, the query optimizer selects one of the query plans (e.g., the least costly, etc.) and executes the database query based on the selected query plan.

In situations where a user has limited/permissioned access to data records within the database, the query optimizer often generates a query plan based on the costs and executes the query to retrieve all of the database records for that particular tenant. After loading the database records in their entirety, the database then filters out the records which the user does not have permission to access and returns the results. However, this process requires the database to retrieve all database records even those that the user does have privileges to access which is unnecessarily inefficient.

### SUMMARY

One example embodiment provides an apparatus that includes a memory configured to store an index that comprises identifiers of access privileges for a plurality of users with respect to a database, and a processor configured to receive a database query associated with a user from a software program, identify data records within the database that the user has permission to access based on database accessibility rights of the user stored within the index, prior to execution of the database query, load the identified data records that the user has permission to access into the memory and filter out other data records from the database which the user does not have permission to access, and execute the database query on the identified data records loaded from the database and return query results from the execution to the software program.

Another example embodiment provides a method that includes one or more of storing an index that comprises identifiers of role-based access privileges for a plurality of users with respect to a database, receiving a database query associated with a user from a software program, identifying data records within the database that the user has permission to access based on database accessibility rights of the user stored within the index, prior to execution of the database query, loading the identified data records that the user has permission to access into the memory and filtering out other data records from the database which the user does not have permission to access, and executing the database query on the identified data records loaded from the database and returning query results from the execution to the software program.

A further example embodiment provides a computer-readable medium comprising instructions, that when read by a processor, cause the processor to perform one or more of storing an index that comprises identifiers of role-based access privileges for a plurality of users with respect to a database, receiving a database query associated with a user from a software program, identifying data records within the database that the user has permission to access based on database accessibility rights of the user stored within the index, prior to execution of the database query, loading the identified data records that the user has permission to access into the memory and filtering out other data records from the database which the user does not have permission to access, and executing the database query on the identified data records loaded from the database and returning query results from the execution to the software program.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a diagram illustrating a cloud computing environment according to an example embodiment.

FIG. 1B is a diagram illustrating a cloud computing environment according to another example embodiment.

FIG. 2A is a diagram illustrating abstraction model layers of a cloud computing environment according to an example embodiment.

FIG. 2B is a diagram illustrating a process of executing a database query based on user-based data permissions according to an example embodiment.

FIGS. 3A-3C are diagrams illustrating examples of a permissioned network according to example embodiments.

FIG. 3D is a diagram illustrating machine learning process via a cloud computing platform according to an example embodiment.

FIG. 3E is a diagram illustrating a quantum computing environment associated with a cloud computing platform according to an example embodiment.

FIG. 4A is a diagram illustrating an example of an index storing user-based data permissions and an underlying storage structure according to example embodiments.

FIG. 4B is a diagram illustrating a process of filtering database records prior to performing a join operation of a database query according to example embodiments.

FIG. 4C is a diagram illustrating a process of reducing an amount of storage consumed by the index according to example embodiments.

FIGS. 4D and 4E are diagrams illustrating additional features of the index storing user-based data permissions according to example embodiments.

FIG. 5 is a diagram illustrating a method of filtering a database query prior to loading the data records of the database according to an example embodiment.

FIG. 6 is a diagram illustrating an example of a computing system that supports one or more of the example embodiments.

### DETAILED DESCRIPTION

It is to be understood that although this disclosure includes a detailed description of cloud computing, implementation of the teachings recited herein is not limited to a cloud computing environment. Rather, embodiments of the present invention are capable of being implemented in conjunction with any other type of computing environment now known or later developed.

A database query is a request for information from a database. An example of a database query is a structured query language (SQL) query. However, it should be appreciated that many other query languages are also applicable. When received by the database, the query is processing on tables of data (columns/rows) in the database in a way that yields the requested information. Since database structures can be complex, in most cases, the data can be accessed in different ways, through different data-structures, and in different orders. Each different way typically requires different processing time.

Processing times of a query may have large variance, from a fraction of a second to hours, depending on the chosen method of accessing the underlying data associated with the query from the database. Therefore, in many cases, a query optimization is performed to minimize the response time of a database query by making the best use of system resources. The best use of these resources may be obtained by minimizing/reducing network traffic, disk I/O, CPU time, and the like. The purpose of query optimization, which is an automated process, is to find the way to process a given query in a minimum “cost” which can be based on time and possible other factors such as network traffic, disk I/O, CPU time, etc. Finding an exact optimal query plan, among all possibilities, is typically very complex, time-consuming, costly, and often practically impossible. As a result, query optimization typically approximates the optimum query plan by comparing several common-sense alternatives which typically does not deviate much from the best possible result.

One of the delays in processing a database query is that when a database query is received, for example, from a software application, etc., the database loads all of the data from the tables identified in the database query. Then, the database executes the database query to generate a set of results. If a user has access privileges with respect to the database, the database may then compare the results of the database query to the user's privileges to determine which records should not be delivered to the user. One common reason for performing the filtering process in this way is that it is easier to filter database records at an upper level of the software stack (i.e., when the query results are known and ready to be returned to the user) rather than at the beginning of the software stack which performs the database access.

That being said, the traditional filtering process requires all of the table data to be read, regardless of whether the table data is accessible/permitted to be viewed by the user. In many cases, a user is only authorized to access some of the data within a table but not all of the data within a table. This is common in a multi-tenant environment of a host platform such as a cloud platform. Therefore, reading all of the table data can be a very inefficient process that consumes unnecessary query optimization planning and data loading/processing.

The present application overcomes the drawbacks of the traditional filtering process of a database query based on a user's permissions by filtering the database/records prior to loading the database records from the database. Accordingly, only the database records from a database table that are permitted to be viewed by the user may be loaded from the database and processed during the query rather than all database records from the database table (when the database table includes records of one or more other users, etc.). As a result, database records that are not permitted to be viewed by the user may not be loaded thereby increasing the security of the data. Furthermore, by only loading some, but not all of the table data, the loading process is sped up significantly in comparison to traditional database query processing. The database may manage an index which contains data access permissions of various users of the database. The database may consult the index when performing the query optimization to derive an optimal query plan in lieu of the permissions of a particular user that submitted the query.

As an example, the database could be a multi-tenancy database managed by a cloud provider and used with a software as a service (SaaS) or a desktop as a service (DaaS) hosted by the cloud provider. In these examples, users do not manage the operating system and the database/storage within the database. Rather, the cloud provider manages the data and how the data is stored. Furthermore, the cloud provider also determines how to share the underlying database tables with different users and isolate the data based on different roles/rules in a same table. Different users may access the tables but can only read and change part of data according to their credentials. The database described herein can provide a mechanism to avoid the user gaining access or even loading data that the user is not authorized to have access to such as data belonging to other users in the same database table.

Most database products manage the roles/users at an upper level of the database architecture. Meanwhile, the query optimizer and the query implementation components are normally at the bottom of the database architecture. As a result, the user's permissions to access database data are applied after the table data has been read by the database and a database query has been executed to retrieve the data records associated therewith. Thus, the entire database table must be loaded from memory and the user permissions checked/applied after the table data has been loaded to ensure compliance and prevent access to data that the user is not authorized to access. However. the data of other users, which the user is unauthorized to have access to, is still read by the database while processing the query. In the present application, the database filters the database records at the lower level of the database where the query processing is performed. Thus, only the data records which a user is permitted to view/access can be loaded from a database table rather than the entire database table.

Below is an example of a database query.
SELECT*FROM (Employee.TableA)
   JOIN Department.TableB on A.Dep_ID=B.Dep_ID
   WHERE current user=a.manager and a.salary<5000

In this example, the database query is a query to retrieve data from a database table “Employee.TableA” and join it with data from a table “Department.TableB” using a condition based on salary. Based on the index described in the example embodiments which manages user permissions, the query engine/query optimizer of the database may filter the table “Employee.TableA” and choose only the records that current user who submitted the query is permitted to access. As an example, the user may be identified from the database query itself such as in the form of an internet protocol (IP) address, MAC address, a user name, a unique identifier, or the like. After the filtering, the query engine may get a bit list which could be used to merge with another bit list that is filtered using the condition of (a.salary<5000), which may be generated according to another index on column “a.salary”. The database can use the result-set of merging to join with table Department.TableB. The result-set of merging only includes the employees managed by current user; it is a very small result-set that removes unnecessary data before the JOIN operation performed in this query.

On the other hand, within the new index described in the example embodiments, query engine would need to join all the employees whose salary<5000 with the table Department.TableB, and then filter the result-set of the join to find the employees who have the same name as the current user name. The join processing would require significantly more runtime because the query engine would need to join a significantly greater number of unnecessary records of employees who were not the current user.

The cloud platform may manage a database for the applications that are hosted by the cloud platform. The cloud provider is typically in charge of deciding where and how the application data is stored within the database.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Examples of cloud computing characteristics that may be associated with the example embodiments include the following.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Examples of service models that may be associated with the example embodiments include the following:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Examples of deployment models that may be associated with the example embodiments include the following:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

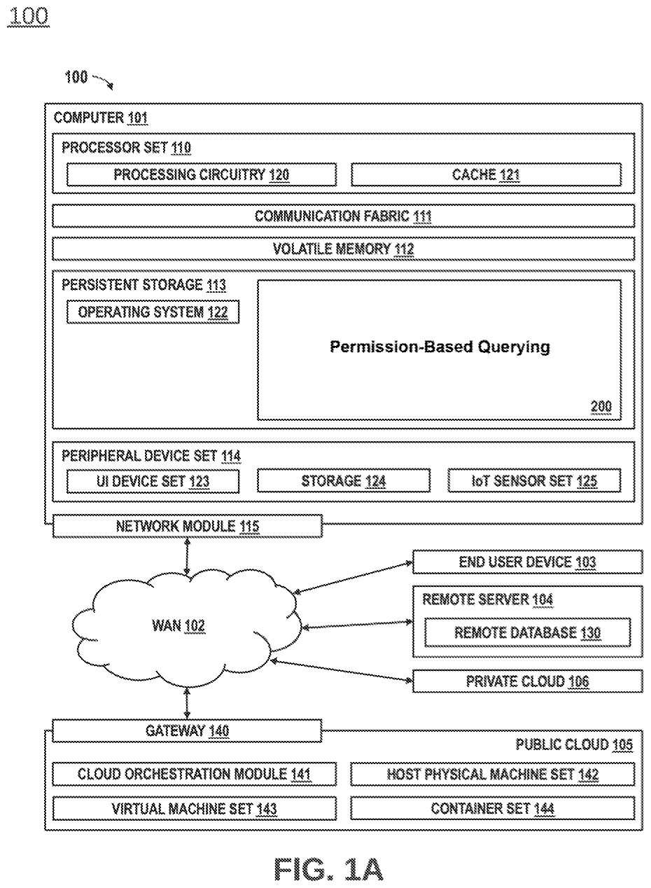

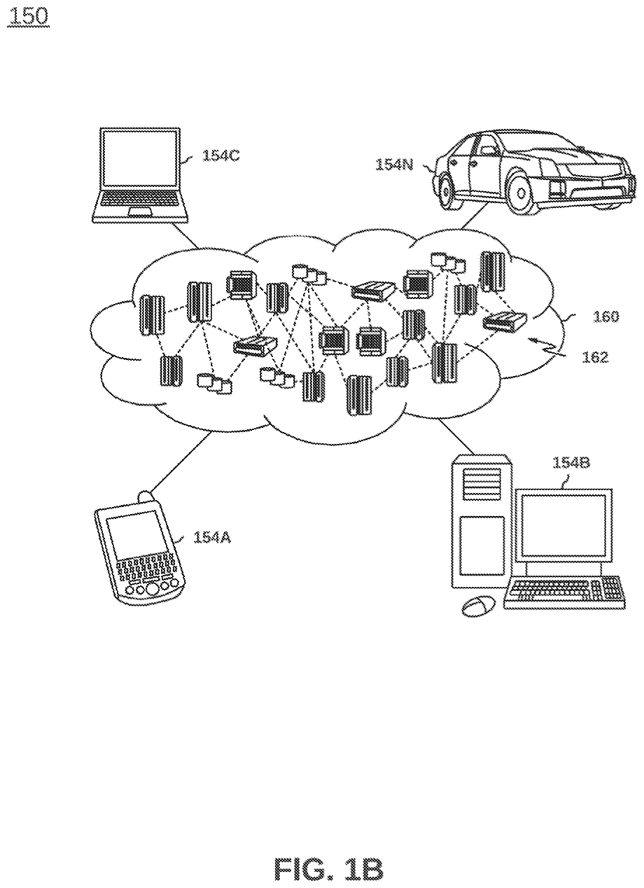

Referring now to FIG. 1A, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as distributed training using bottom-up aggregation as shown in block 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction paths that allow the various components of computer 101 to communicate with each other. Typically, this fabric comprises switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

Referring now to FIG. 1B, an illustrative cloud environment 150 is depicted. As shown, cloud computing environment 160 includes one or more cloud computing nodes 162 with which local computing devices used by cloud consumers, such as, for example, personal digital assistant (PDA) or cellular telephone 154A, desktop computer 154B, laptop computer 154C, and/or automobile computer system 154N may communicate. Nodes 162 may communicate with one another. They may be grouped (not shown) physically or virtually in one or more networks, such as Private, Community, Public, or Hybrid clouds as described hereinabove, or a combination thereof. This allows cloud computing environment 160 to offer infrastructure, platforms and/or software as services for which a cloud consumer does not need to maintain resources on a local computing device. It is understood that the types of computing devices 154A-N shown in FIG. 1B are intended to be illustrative only and that computing nodes 162 and cloud computing environment 160 can communicate with any type of computerized device over any type of network and/or network addressable connection (e.g., using a web browser).

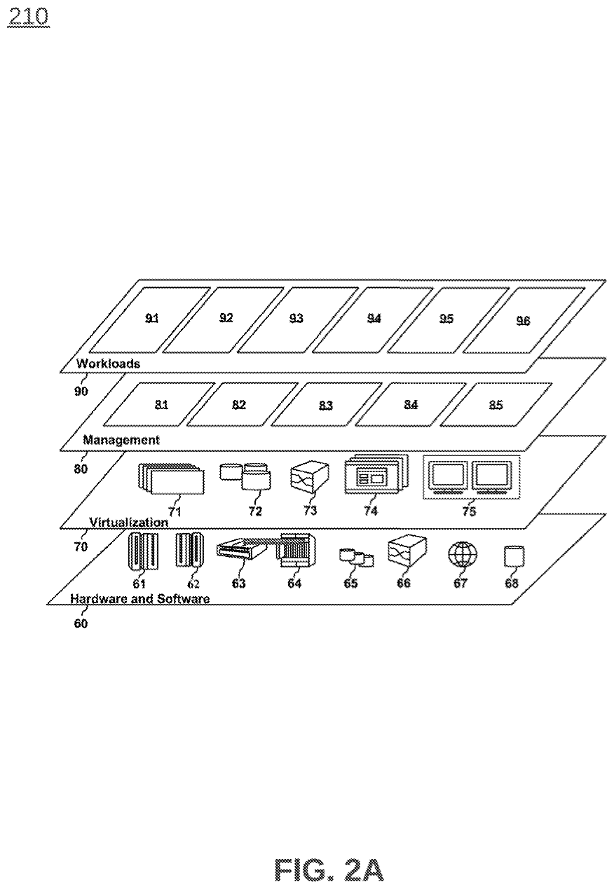

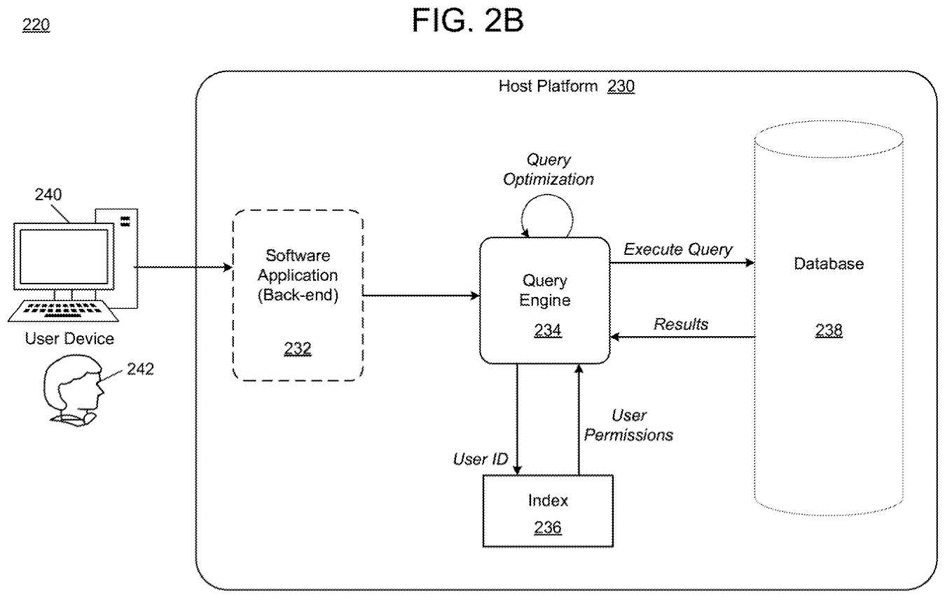

Referring now to FIG. 2A, a set of functional abstraction layers provided by cloud computing environment 50 FIG. 1) is shown. It should be understood in advance that the components, layers, and functions shown in FIG. 2A are intended to be illustrative only and embodiments of the invention are not limited thereto. As depicted, the following layers and corresponding functions are provided: Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workload layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and query processing 96.

FIG. 2B illustrates a process 220 of executing a database query based on user-based data permissions according to an example embodiment. For example, the process 220 may be performed by the query processing 96 shown in FIG. 2A. Referring to FIG. 2B, a host platform 230 such as a cloud platform, a web server, a distributed computing environment, and/or the like, may host a software application 232 such as a progressive web application (PWA), a mobile application, a software application, or other software program. Users may access the software application 232 via computing devices that connect to the host platform 230 via the Internet. In FIG. 2B, a user device 240 associated with a user 242 is connected to the host platform 230 and interacting with the software application 232.

In this example, the software application 232 may have many users with different roles/permissions among them. In some cases, the permissions may be managed per user (i.e., individually). As another example, the permissions may be managed for groups of users (e.g., subsets of users, all users, etc.) According to various embodiments, an index 236 may be generated by the database 238 which includes indicators of the permissions of the users of the database with respect to the data records stored in the database 238. The permissions may be managed based on ranges of data identifiers rather than entire tables. Thus, a user may receive permission to only a part of a database table, but not all of the database table. The location of the data from the database table that the user has permission to access may be represented with a pointer in the index 236 which points to a memory address where the data is stored. For example, the index 236 can include a two-dimensional array of pointers in which a first dimension represents ranges of data identifiers and the second dimension represents different users. Thus, multiple users can be represented with the same index 236.

In FIG. 2B, a query engine 234 receives the database query from the software application 232, identifies a user associated with the query (e.g., based on an identifier in the query, an IP address, etc.), and accesses the index 236 to read the permissions of the identified user. The query engine 234 may include various components such as a query optimizer, a query planner/estimator, and the like. Next, the query engine 234 may identify one or more database tables within the database 238 which contain the data for the query. Furthermore, based on the data read from the index 236, the query engine 234 may identify a first subset of data within the one or more database tables which the user is permitted to access and a second subset of data within the one or more database tables which the user cannot access. During query execution, the query engine 234 may load only the first subset of data from the database 238 during the query runtime while excluding the second subset of data from one or more tables stored in the database 238 from being read and from being considered by the query engine 234. The resulting conditions within the query may be processed on only the first subset of data records read from the one or more database tables without considering the second subset of data records which are excluded from being loaded. Thus, an efficient query processing can be performed.

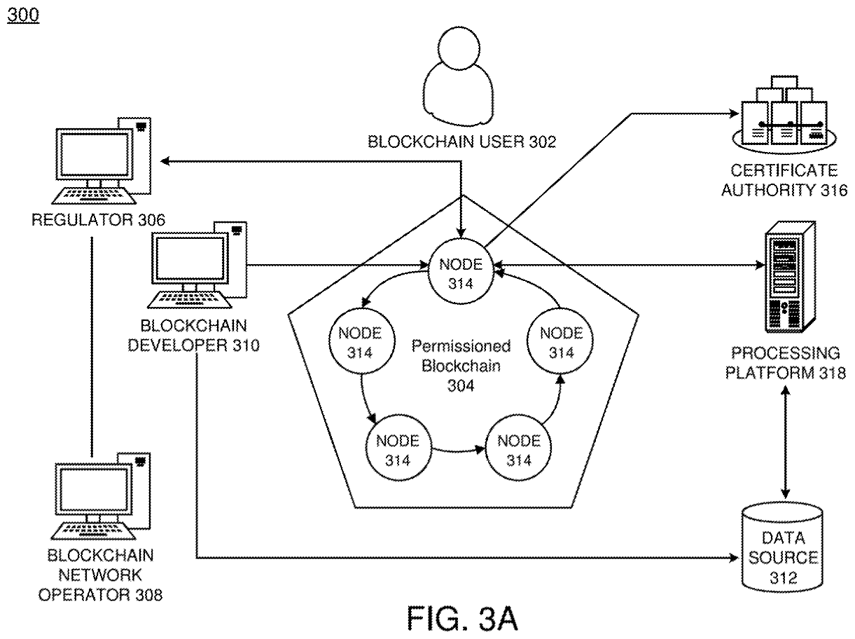

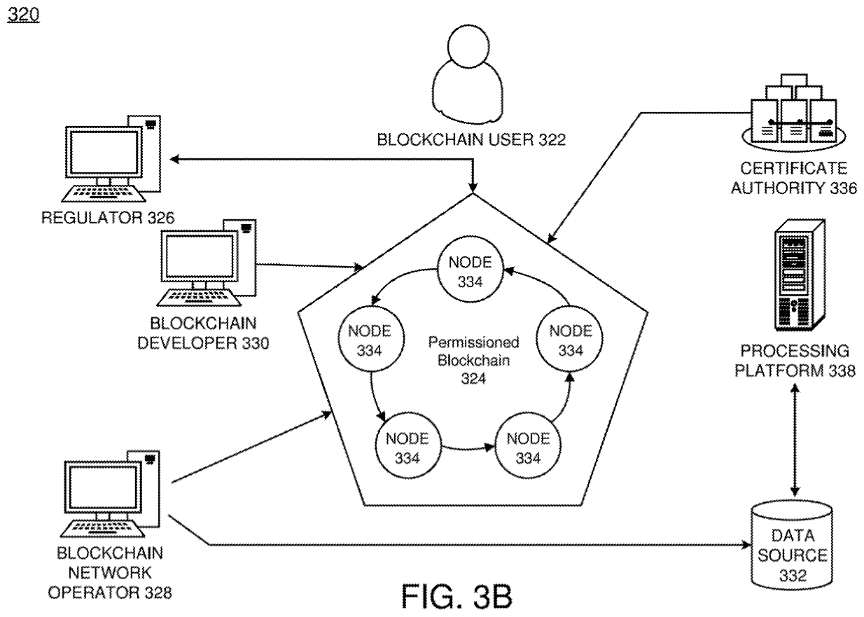

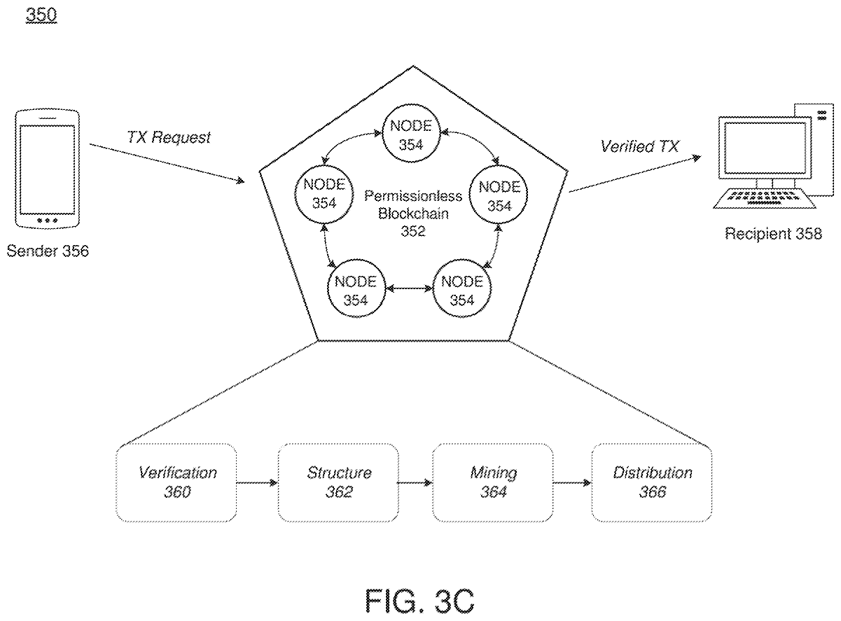

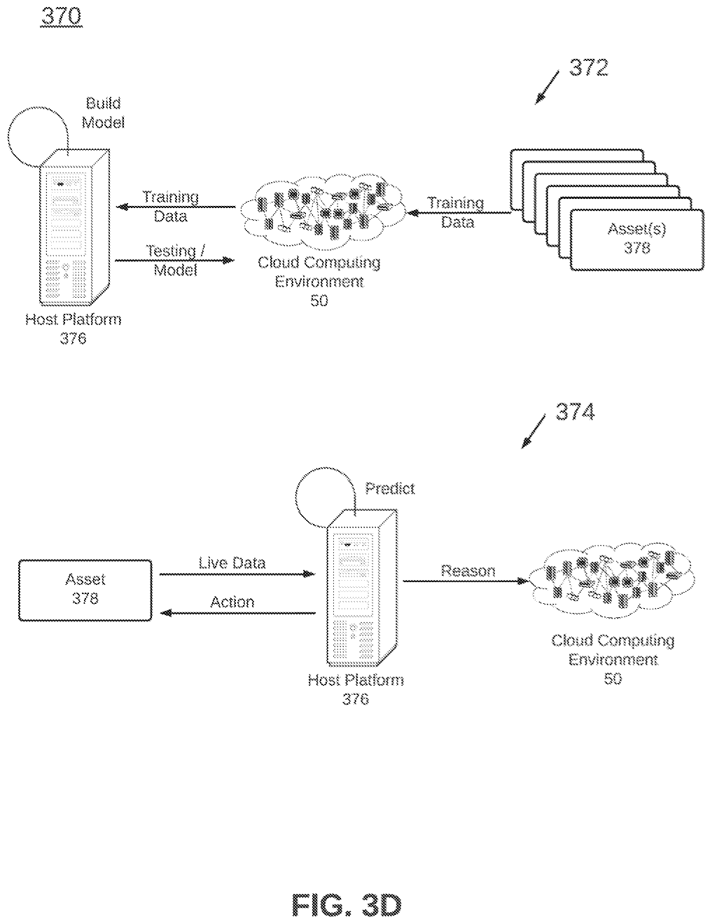

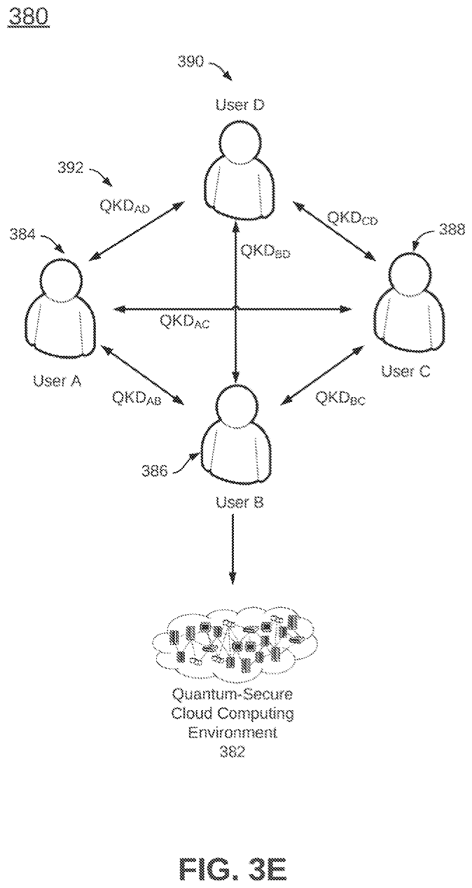

FIGS. 3A-3E provide various examples of additional features that may be used in association with the cloud computing environment described herein. These examples should be considered as additional extensions or additional examples of the embodiments described herein.

FIG. 3A illustrates an example of a permissioned blockchain network 300, which features a distributed, decentralized peer-to-peer architecture. The blockchain network may interact with the cloud computing environment 50, allowing additional functionality such as peer-to-peer authentication for data written to a distributed ledger. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 3C illustrates a process 350 of a transaction being processed by a permissionless blockchain 352 including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying identities of the parties involved, etc. The transaction may be verified immediately or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

FIGS. 3D and 3E illustrate additional examples of use cases for cloud computing that may be incorporated and used herein. FIG. 3D illustrates an example 370 of a cloud computing environment 50 which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376 builds and deploys a machine learning model for predictive monitoring of assets 378. Here, the host platform 366 may be a cloud platform, an industrial server, a web server, a personal computer, a user device, and the like. Assets 378 can be any type of asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 50 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 50. This can significantly reduce the collection time needed by the host platform 376 when performing predictive model training. For example, data can be directly and reliably transferred straight from its place of origin to the cloud computing environment 50. By using the cloud computing environment 50 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the data associated therewith) may be stored on the cloud computing environment 50 by the host platform 376. Each refinement of the machine learning model (e.g., changes in variables, weights, etc.) may be stored in the cloud computing environment 50 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 50.

After the model has been trained, it may be deployed to a live environment where it can make predictions/decisions based on the execution of the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by the execution of the machine learning model at the host platform 376 may be stored on the cloud computing environment 50 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 50. In one embodiment the features and/or the actions described and/or depicted herein can occur on or with respect to the cloud computing environment 50.

FIG. 3E illustrates an example 380 of a quantum-secure cloud computing environment 382, which implements quantum key distribution (QKD) to protect against a quantum computing attack. In this example, cloud computing users can verify each other's identities using QKD. This sends information using quantum particles such as photons, which cannot be copied by an eavesdropper without destroying them. In this way, a sender, and a receiver through the cloud computing environment can be sure of each other's identity.

In the example of FIG. 3E, four users are present 384, 386, 388, and 390. Each pair of users may share a secret key 392 (i.e., a QKD) between themselves. Since there are four nodes in this example, six pairs of nodes exist, and therefore six different secret keys 392 are used including QKDAB, QKDAc, QKDAD, QKDBc, QKDBD, and QKDcD. Each pair can create a QKD by sending information using quantum particles such as photons, which cannot be copied by an eavesdropper without destroying them. In this way, a pair of users can be sure of each other's identity.

The operation of the cloud computing environment 382 is based on two procedures (i) creation of transactions, and (ii) construction of blocks that aggregate the new transactions. New transactions may be created similar to a traditional network, such as a blockchain network. Each transaction may contain information about a sender, a receiver, a time of creation, an amount (or value) to be transferred, a list of reference transactions that justifies the sender has funds for the operation, and the like. This transaction record is then sent to all other nodes where it is entered into a pool of unconfirmed transactions. Here, two parties (i.e., a pair of users from among 384-390) authenticate the transaction by providing their shared secret key 392 (QKD). This quantum signature can be attached to every transaction making it exceedingly difficult to be tampered with. Each node checks its entries with respect to a local copy of the cloud computing environment 382 to verify that each transaction has sufficient funds.

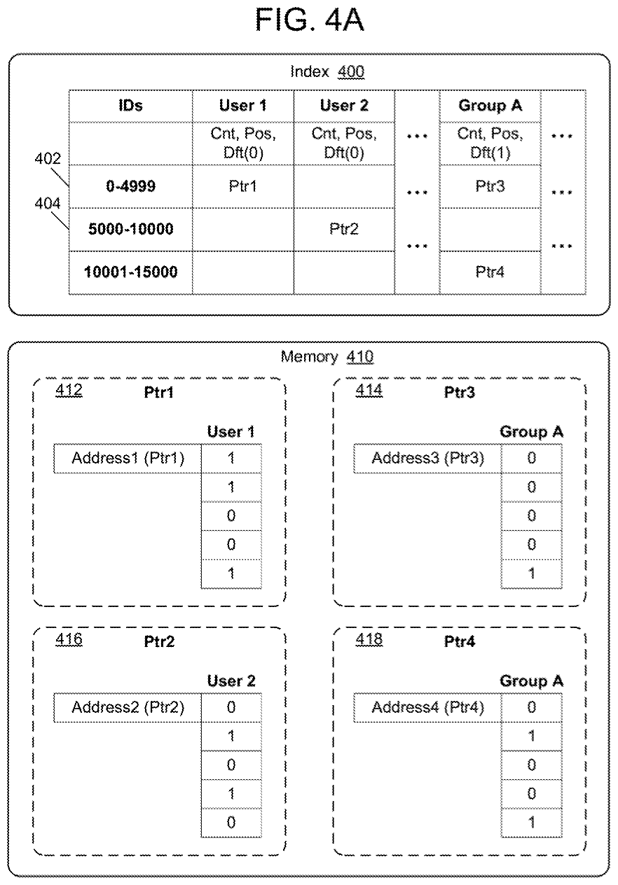

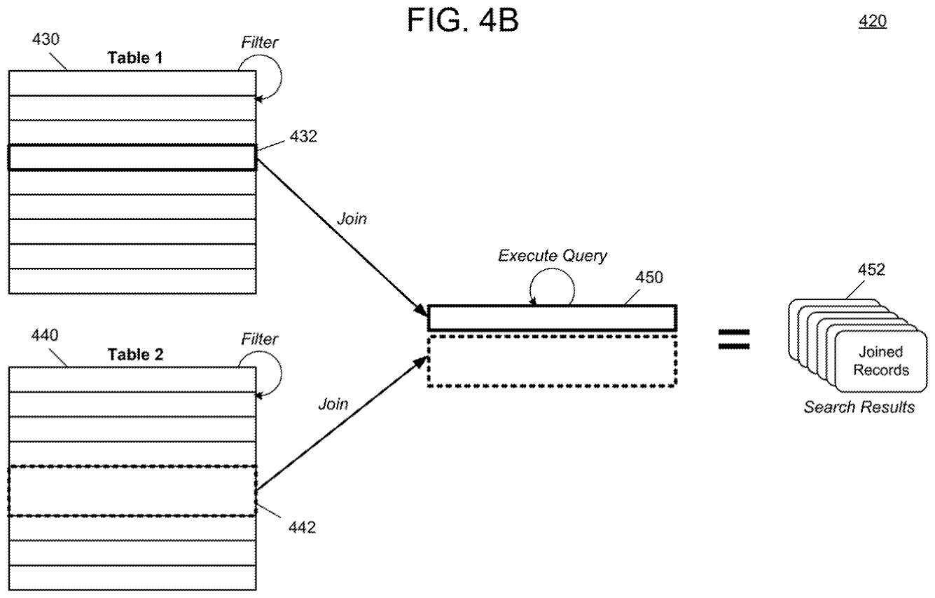

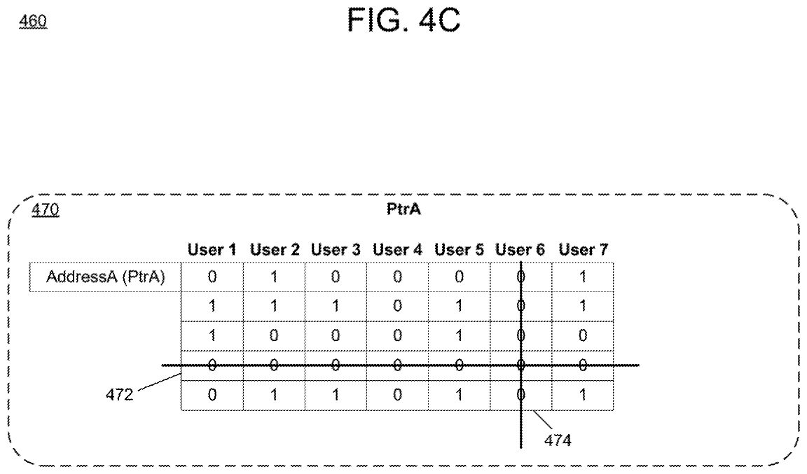

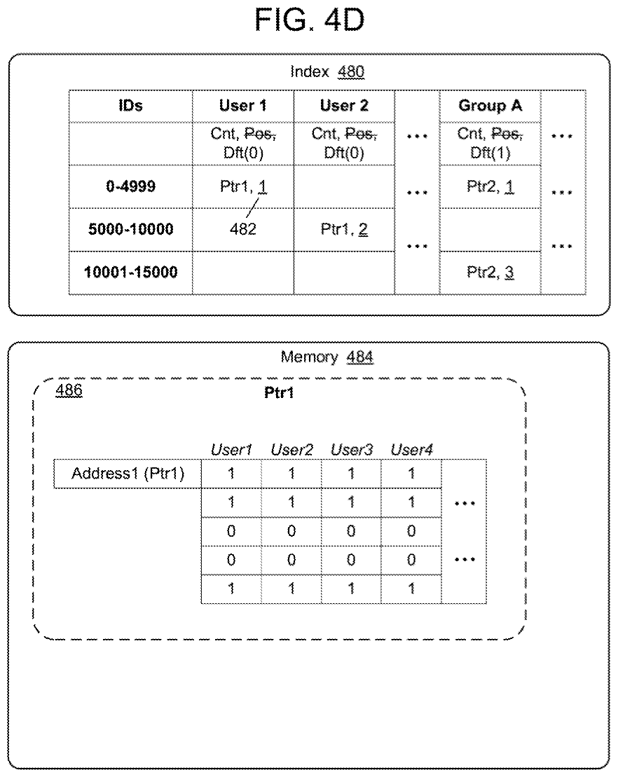

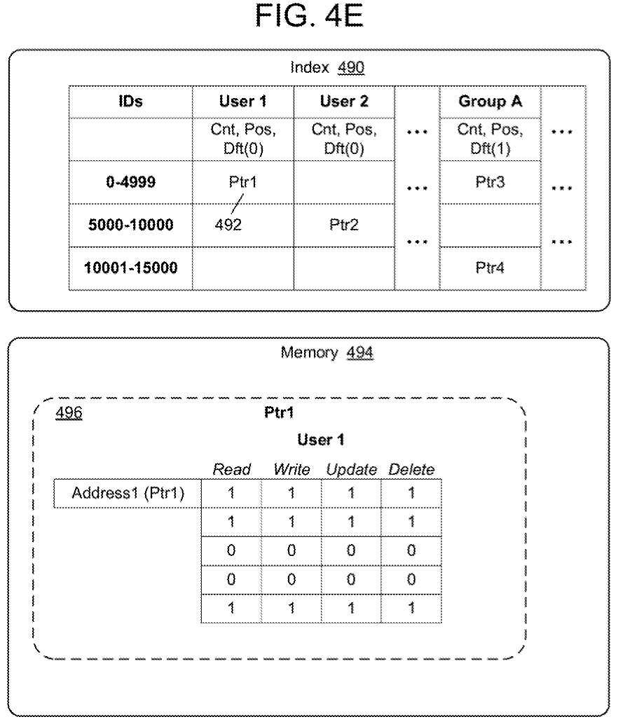

FIG. 4A illustrates an example of an index 400 storing user-based data permissions and an underlying storage structure 410 associated with the index 400 according to example embodiments. Referring to FIG. 4A, the index 400 includes a two-dimensional array in which data identifiers are used to represent different rows in a first dimension of the array and user identifiers are used to represent different columns in a second dimension of the array. In this example, the data identifiers refer to a single database table with a range of data identifiers from 0 to 15000. The index 400 includes ranges of data identifiers which are used to divide the index.

For example, a first row 402 within the index 400 represents data identifiers 0 to 4999. In this example, the first user and the Group A each have permission to access the data records stored at the data identifiers within the range of 0 to 4999 while the user 2 does not have permission to access the data records. The permissions are indicated by pointers (ptr). In the first row 402, user 1 has a pointer (Ptr1) and Group A has a pointer (Ptr3). Each pointer may point to a different location within the database (memory 410) where the database records associated with the range of data identifiers are stored. For example, a pointer may include a bit address, a byte address, or the like. Likewise, a second row 404 within the index represents data identifiers 5000 to 9999. In this example, the second user has permission to access the data records stored within data identifiers 5000-9999 but the user 1 and Group A do not have permission to access the data records.

Below the index 400 is the memory locations within the database where the pointers within the index point to. For example, the first pointer (Ptr1) referring to user 1 and the data identifiers in the range of 0-4999 is stored at a memory address 412. Here, the user's access is further represented using a bit array where each bit represents a different subset of data identifiers within the larger rand of data identifiers 0-4999. For example, each bit may represent 1000 bits (0-999, 1000-1999, 2000-2999, 3000-3999, and 4000-4999). In this example, a bit value of “1” indicates the user has permission to access the data records stored at that range. As noted at memory address 412, the first user has access to data records between bits 0-999, 1000-1999, and 4000-4999, but not to the data records stored at 2000-2999 and 3000-3999, as indicated by the bit array. The granularity of the cells in the index 400 and the bit arrays stored in the memory 410 may be configurable and adjusted by the users of the system. The other pointers stored within the index 400 are shown in the memory 410 including pointers 414, 416, and 418 corresponding to pointers Ptr2, Ptr3, and Ptr4, respectively.

FIG. 4B illustrates a process 430 of filtering database records prior to performing a join operation of a database query according to example embodiments. Referring to FIG. 4B, a query engine may execute a join operation based on a database query from a user to join data from database tables 430 and 440, respectively. Here, the query engine may filter the table data (data records) within each of the respective database tables 430 and 440, prior to executing the join operation, such that only data that is accessible to the user is loaded from the database tables 430 and 440 while other data from the database tables 430 and 440 which is not accessible/authorized for access by the user is not loaded.

For example, the filtering process may identify a first subset 432 of data records within the database table 430 that is accessible/viewable for the user, and a second subset of data records 442 within the database table 440 which is accessible/viewable for the user. Meanwhile, the query engine may exclude any remaining database records within the database tables 430 and 440 during a load operation from the database tables 430 and 440. For example, only the first subset 432 of data records may be retrieved from the database table 430 while the remaining data records are excluded.

In 450, the query engine may execute the query logic on only those data records which the user has authorization to view/access. That is, the query engine may execute the database join operation on only the first subset 432 of data records and the second subset 442 of data records from the database tables 430 and 440. The result of the joint operation is joined data records 452. By filtering the data records within the database tables 430 and 440 before the join operation, the query engine can remove any unnecessary data records before the join operation is ever run/executed.

FIG. 4C illustrates a process 460 of maintaining an index according to various embodiments by reducing an amount of storage consumed by the index. Periodically or conditionally (e.g., each time user permissions are updated, etc.) the database may execute a maintenance operation on the index to reduce the size/storage of the underlying memory associated with the index. In FIG. 4C, a pointer within the index points to a memory address 470 which includes a two-dimensional bit array that represents permissions of a plurality of users associated with a sub-portion of a database table. Here, none of the users are given access to a row 472 of data identifiers (e.g., data identifiers 3000-3999, etc.) Thus, the database can delete this row 472 from the bit array stored in memory. Likewise, the database can delete a column 474 within the bit array that corresponds to user 6 since the column is all zeros. The same could be true if the column/row were all l's, etc.

Other maintenance and management of the index and the underlying memory structure may also be performed. For example, the filtering process itself may be performed as part of a final cost estimation step performed by the query optimizer thereby considering the cost of accessing such filtered data records during the query optimization. Furthermore, the system can work together with multiple indexes to create merge lists of bits that can be accessed/loaded by the database query. Furthermore, the index could be even more accurate by providing a position number within the pointer which points to a particular bit position(s) within the bit array stored in the memory, etc. As another example, more bits could be added to the index to specify authority for actions such as reading, updating, deleting, writing, etc. providing even more customizations. The system can access/read a list of users and permissions of each of the users from a stored location known in advance.

FIGS. 4D and 4E illustrates additional features of the index storing user-based data permissions according to example embodiments. Referring to FIG. 4D, an index 480 is shown which includes a pointer 482 with a position value associated therewith that identifies a column in the bit array from among a plurality of columns stored in the underlying bit array. In the example of FIG. 4D, the pointer 482 includes a position value of ‘1’ meaning that the location of the user permissions are located in the first column of the bit array. Other positional information may be used including byte locations, row identifiers, column identifiers, and the like. By storing the position information inside the pointer itself, the permissions of the respective user can be quickly identified.

Referring to FIG. 4E, an index 490 is shown which includes a pointer 492 which points to a bit array located in storage structure 496. Here, the pointer 492 points to a bit array of different permissions of the same user. For example, the first column in the bit array within the storage structure 496 is for read permissions, while the second column in the bit array is for write permissions. Additional bits may be added for additional types of permissions thereby enabling more customization and more precision with the data that needs to be loaded from the database when processing a database query. In some embodiments, both types of extensions (i.e., moving the position bit into the pointer and adding additional bits in the bit array for different permission types) may be used in the same index, however, they are shown separately here for convenience.

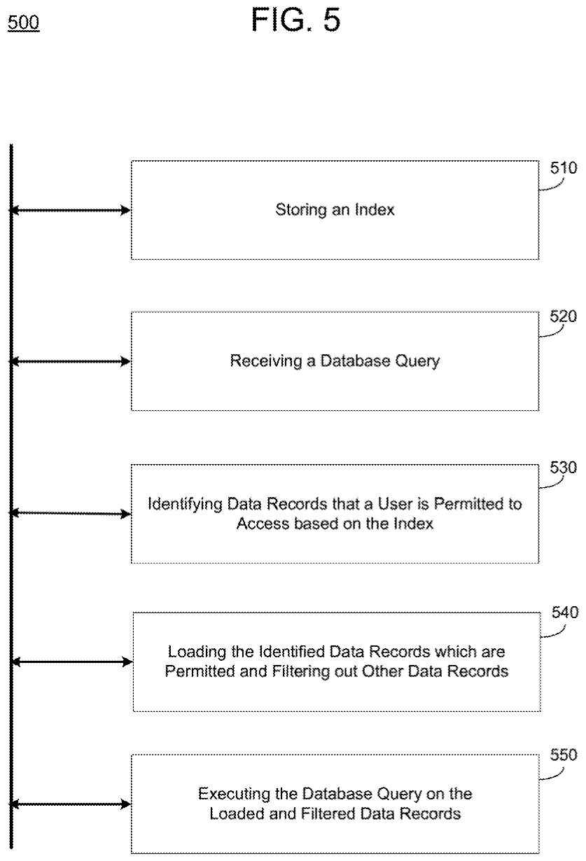

FIG. 5 is a diagram illustrating a method of filtering a database query prior to loading the data records of the database according to an example embodiment. For example, the method 500 may be performed by a computer system such as a cloud platform, a database, a web server, a personal computer or other user device, and the like. Referring to FIG. 5, in 510 the method may include storing an index that comprises identifiers of role-based access privileges for a plurality of users with respect to a database. In 520, the method may further include receiving a database query associated with a user from a software program.

In 530, the method may include identifying data records within the database that the user has permission to access based on database accessibility rights of the user stored within the index. In 540, the method may include, prior to execution of the database query, loading the identified data records that the user has permission to access into the memory and filtering out other data records from the database which the user does not have permission to access. In 550, the method may include executing the database query on the identified data records loaded from the database and returning query results from the execution to the software program.

In some embodiments, the index may include a two-dimensional array of cells, a plurality of columns that represent a plurality of users, a plurality of rows that represent a plurality of ranges of identifiers, and indicators stored within the cells which identify access privileges of the plurality of users. In some embodiments, the method may further include identifying the user based on a user identifier embedded within the database query which is received from the software program. In some embodiments, the method further comprises generating, via a query optimizer, a query plan for the database query based on the database accessibility rights of the user stored in the index. In some embodiments, the method further include generating a plurality of cost estimates for a plurality of possible query plans of the database query based on the database accessibility rights of the user stored in the index, and select the query plan from among the plurality of possible query plans based on the plurality of cost estimates.

In some embodiments, the method may include executing a maintenance operation on the index and remove one or more columns from the index that comprises all zero values therein. In some embodiments, the index may include a two-dimensional array of cells, and the cells contain pointers to addresses which store access permissions of database accessibility rights of the plurality of users. In some embodiments, the index may store more columns of database accessibility rights for the user than one or more other users among the plurality of users.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

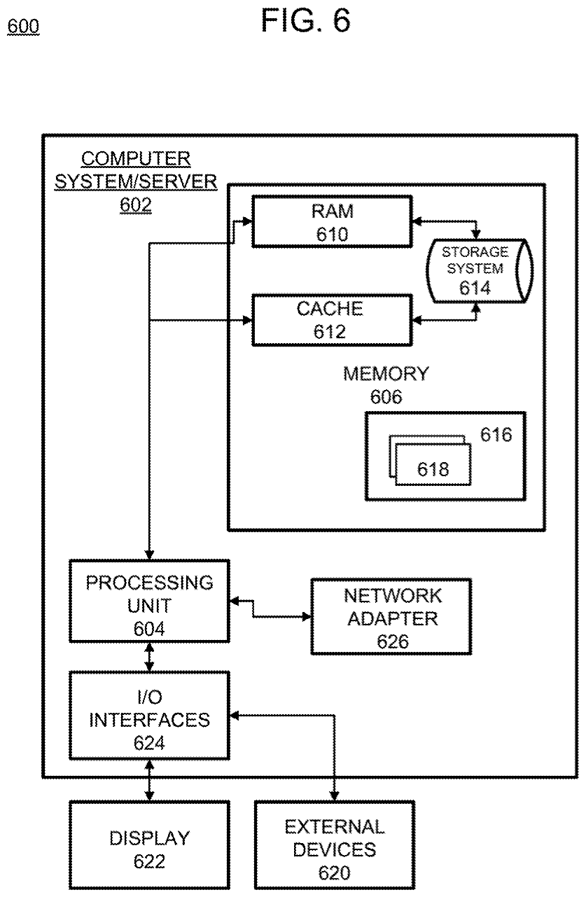

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example computer system architecture 600, which may represent or be integrated in any of the above-described components, etc.

FIG. 6 illustrates an example system 600 that supports one or more of the example embodiments described and/or depicted herein. The system 600 comprises a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in cloud computing node 600 is shown in the form of a general-purpose computing device. The components of computer system/server 602 may include, but are not limited to, one or more processors or processing units 604, a system memory 606, and a bus that couples various system components including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules 618 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624. Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. An apparatus comprising:
a memory configured to store an index that comprises identifiers of access privileges for a plurality of users with respect to a database; and
a processor configured to
receive a database query associated with a user from a software program,
identify data records within the database that the user has permission to access based on database accessibility rights of the user stored within the index,
prior to execution of the database query, load the identified data records that the user has permission to access into the memory and filter out other data records from the database which the user does not have permission to access, and
execute the database query on the identified data records loaded from the database and return query results from the execution to the software program.

2. The apparatus of claim 1, wherein the index comprises a two-dimensional array of cells, a plurality of columns that represent a plurality of users, a plurality of rows that represent a plurality of ranges of identifiers, and indicators stored within the cells which identify access privileges of the plurality of users.

3. The apparatus of claim 1, wherein the processor is further configured to identify the user based on a user identifier embedded within the database query which is received from the software program.

4. The apparatus of claim 1, wherein the processor is configured to generate, via a query optimizer, a query plan for the database query based on the database accessibility rights of the user stored in the index.

5. The apparatus of claim 4, wherein the processor is configured to generate a plurality of cost estimates for a plurality of possible query plans of the database query based on the database accessibility rights of the user stored in the index, and select the query plan from among the plurality of possible query plans based on the plurality of cost estimates.

6. The apparatus of claim 1, wherein the processor is configured to execute a maintenance operation on the index and remove one or more columns from the index that comprises all zero values therein.

7. The apparatus of claim 1, wherein the index comprises a two-dimensional array of cells, and the cells contain pointers to addresses which store access permissions of database accessibility rights of the plurality of users.

8. The apparatus of claim 1, wherein the index stores more columns of database accessibility rights for the user than one or more other users among the plurality of users.

9. A method comprising:
storing an index that comprises identifiers of role-based access privileges for a plurality of users with respect to a database;
receiving a database query associated with a user from a software program;
identifying data records within the database that the user has permission to access based on database accessibility rights of the user stored within the index;
prior to execution of the database query, loading the identified data records that the user has permission to access into the memory and filtering out other data records from the database which the user does not have permission to access; and
executing the database query on the identified data records loaded from the database and returning query results from the execution to the software program.

10. The method of claim 9, wherein the index comprises a two-dimensional array of cells, a plurality of columns that represent a plurality of users, a plurality of rows that represent a plurality of ranges of identifiers, and indicators stored within the cells which identify access privileges of the plurality of users.

11. The method of claim 9, wherein the method further comprises identifying the user based on a user identifier embedded within the database query which is received from the software program.

12. The method of claim 9, wherein the method further comprises generating, via a query optimizer, a query plan for the database query based on the database accessibility rights of the user stored in the index.

13. The method of claim 12, wherein the method further comprises generating a plurality of cost estimates for a plurality of possible query plans of the database query based on the database accessibility rights of the user stored in the index, and selecting the query plan from among the plurality of possible query plans based on the plurality of cost estimates.

14. The method of claim 9, wherein the method further comprises executing a maintenance operation on the index and removing one or more columns from the index that comprises all zero values therein.

15. The method of claim 9, wherein the index comprises a two-dimensional array of cells, and the cells contain pointers to addresses which store access permissions of database accessibility rights of the plurality of users.

16. The method of claim 9, wherein the index stores more columns of database accessibility rights for the user than one or more other users among the plurality of users.

17. A computer-readable storage medium comprising instructions, that when read by a processor, cause the processor to perform a method comprising:
storing an index that comprises identifiers of role-based access privileges for a plurality of users with respect to a database;
receiving a database query associated with a user from a software program;
identifying data records within the database that the user has permission to access based on database accessibility rights of the user stored within the index;
prior to execution of the database query, loading the identified data records that the user has permission to access into the memory and filtering out other data records from the database which the user does not have permission to access; and
executing the database query on the identified data records loaded from the database and returning query results from the execution to the software program.

18. The non-transitory computer-readable medium of claim 17, wherein the index comprises a two-dimensional array of cells, a plurality of columns that represent a plurality of users, a plurality of rows that represent a plurality of ranges of identifiers, and indicators stored within the cells which identify access privileges of the plurality of users.

19. The non-transitory computer-readable medium of claim 17, wherein the method further comprises identifying the user based on a user identifier embedded within the database query which is received from the software program.

20. The non-transitory computer-readable medium of claim 17, wherein the method further comprises generating, via a query optimizer, a query plan for the database query based on the database accessibility rights of the user stored in the index.
